(19) United States
(12) Patent Application Publication
(10) Pub. No.: US 2004/0177518 A1
(43) Pub. Date: Sep. 16, 2004

(54) Razor assembly with flexible handle

(76) Inventor: James M. Leventhal, Watertown, MA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/745,257

(22) Filed: Dec. 22, 2003

Related U.S. Application Data
(60) Provisional application No. 60/436,358, filed on Dec. 23, 2002.

(51) Int. Cl. B26B 21/00

(52) U.S. Cl. 30/526

(57) ABSTRACT

A razor assembly comprises a razor blade assembly for supporting a razor blade and a flexible handle, coupled to the razor blade assembly. The flexible handle comprises a substantially flexible material to bend while pressure is applied to the flexible handle.

### CLAIM OF PRIORITY TO PRIOR APPLICATIONS

This application claims priority under 35 U.S.C. § 119(e) to United States provisional patent application Serial No. 60/436,358, filed on Dec. 23, 2002, which is incorporated herein by reference.

### FIELD OF THE INVENTION

The invention relates to razor assemblies, and more particularly to a razor assembly having a blade support coupled to a flexible handle.

### BACKGROUND OF THE INVENTION

Conventional razors are composed of a blade mounted to a rigid handle. Occasionally, the blade mount of the razor is attached to the handle in a moveable manner to account for contours on a surface for which the razor is used. The rigid handle assemblies of conventional razors, however, do not allow the handle to bend in response to the contours of the surface that is being shaved during use. Additionally, traditional, rigid handle assemblies do not easily absorb excess pressure exerted on the handle assembly by the user—pressure that can often times result in painful and messy nicks and cuts on the skin surface. Avoiding unwanted nicks and cuts that occur from shaving with razor assemblies is desirable.

### SUMMARY OF THE INVENTION

It is desirable to have a razor assembly with a pliable handle attached to the blade assembly that allows the user to exert pressure on the handle during shaving, which in turn provides a close, uniform shave. In an aspect of the invention, a razor assembly includes a razor blade assembly for supporting one or more razor blades and a flexible handle coupled to the razor blade assembly. The handle comprises a flexible material to bend while pressure is applied to the handle.

Implementations of the invention may include one or more of the following features. The handle can bend to compensate for any lack of optimum shaving contact between the razor blade and the skin being shaved. The razor blade can be fixedly coupled to the razor blade assembly. The handle can further include a texturized surface for improved gripping.

Other embodiments of the invention may include a razor assembly having a razor blade assembly for supporting a razor blade, and a self-adjusting device, coupled to the razor blade support assembly. The self-adjusting device can comprise a flexible member to bend in response to a pressure applied to the self-adjusting device during use of the razor assembly.

Still further embodiments of the invention can include a razor assembly having a razor blade support assembly for accepting a razor blade and supporting a razor blade or blades, and a pliable handle, coupled to the razor blade support assembly. The pliable handle bends as the blade support assembly travels across a contoured surface to provide substantially uniform pressure on the surface, providing optimal shaving contact between the razor blade and the skin.

Various embodiments of the invention provide one or more of the following advantages. A pliable textured handle absorbs some of the pressure exerted by a user, allowing the blade edge to optimally contact the area being shaved with more uniform pressure, allowing for a safer, more comfortable, shaving experience. By bending in response to the pressure applied by a user, the handle allows the razor blade edge to adjust to the contours of the surface being shaved, thus compensating for any lack of optimum contact between the razor and the skin being shaved.

These and other advantages of the invention, along with the invention itself, will be more fully understood after a review of the following figures, detailed description and claims.

### BRIEF DESCRIPTION OF THE DRAWINGS

For a better understanding of the present invention, reference is made to the figures, which are incorporated herein by reference and in which:

FIG. 1 is a front view of a razor assembly according to the invention;

FIG. 2 is a back view of the razor assembly shown in FIG. 1;

FIG. 3 is a side view of the razor assembly shown in FIGS. 1-2;

FIGS. 4 illustrates a degree of flexibility of a handle of the razor assembly of one embodiment of the invention, shown in FIGS. 1-2; and

FIGS. 5A-5D illustrate the handle of the razor assembly shown in FIGS. 1-4 flexing and/or bending in response to a pressure a user exerts on the handle during use and/or in response to contours on a surface the razor assembly contacts.

### DETAILED DESCRIPTION OF PREFERRED EMBODIMENTS

Embodiments of the invention provide a razor assembly comprising a blade support assembly attached to a handle. Embodiments of the invention can include a handle constructed of a material suitable for providing a pliable consistency and/or flexibility to the assembly to allow one or more blades to adjust to a surface being shaved, allowing constant and consistent optimum shaving contact between the razor blade or blades and the surface being shaved. A suitable material enables the handle and thereby the razor assembly to twist and/or to bend in response to a force exerted to the handle during use to help the assembly to adjust to a surface, such as a pliable plastic. Embodiments of the invention can include any of a number of materials, including, but not limited to, plastics, rubbers, elastomers, metals, papers and any combination thereof.

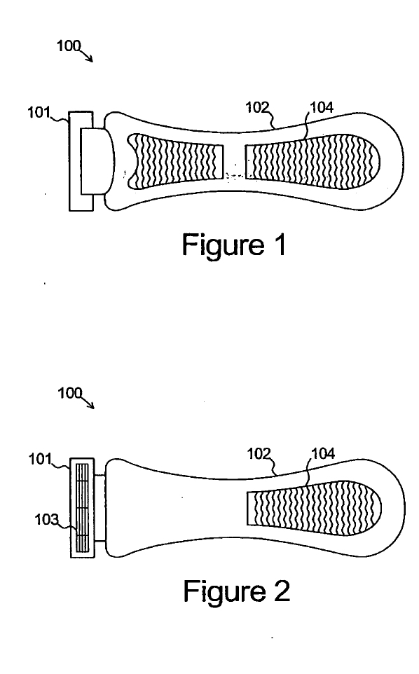

Referring to FIGS. 1 and 2, a razor assembly in accordance with one embodiment of the invention is shown. The razor assembly (100) includes razor blades (103) contained in a blade support assembly (101) attached to a handle (102). The blade support assembly (101) is configured and arranged to receive and to removably hold one or more razor blades (103), e.g., standard, commercially available razor blade cartridges. The razor blade cartridges can be disposable cartridges that are easily removed from the blade support assembly (101) and replaced with new razor blade cartridges when needed. For example, the blade support assembly (100) can include a fastening device, e.g., one or more clips or snaps, that connect with or accept a corresponding fastening device, e.g., one or more clips or snaps, disposed on the replaceable razor blade cartridge (103). In another embodiment, the entire razor assembly (100), including razor blades (103), blade support assembly (101) and handle (102), can be completely disposable.

The handle (102) can be configured in a shape or configuration suitable for providing a user with a comfortable and secure grip. As shown in FIGS. 1 and 2, in one embodiment, the handle (102) can have a shape that includes a mid-portion having a substantially concave shape such that the shape of the handle (102) resembles an hourglass shape. On a surface of the hourglass shape of the handle (102), a texturized surface (104) can be included such that a user of the razor assembly has a grip that reduces slippage. The texturized surface (104) can include substantially the entire handle surface. Alternatively, the texturized surface (104) can be a portion of the surface of the handle (102).

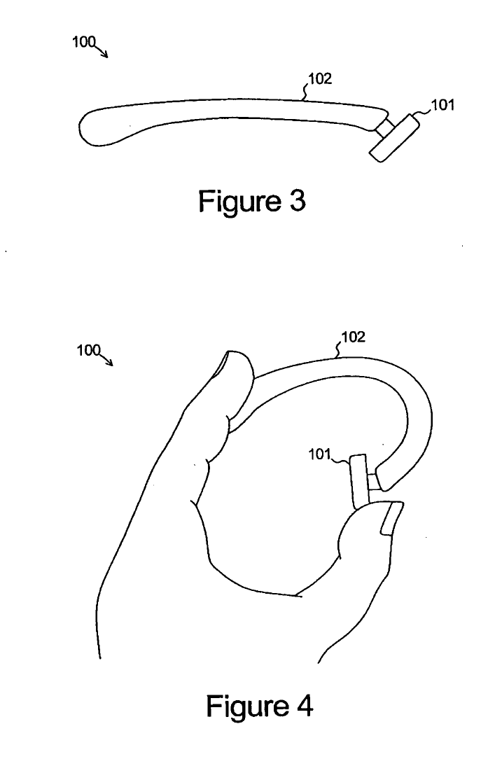

Referring to FIG. 3, a side perspective of the razor assembly (100) reveals that the handle (102) can be substantially flat in shape, although the handle (102) need not be flat. The flatness of the handle (102) can provide an easily gripped surface area for the user. Other handle shapes are possible and envisioned. For example, the handle (102) can be configured in a number of alternative shapes including, but not limited to, round, square, and oblong. The handle (102) can also be convex at a mid-portion, rather than concave.

Referring to FIG. 4, the handle (102) is constructed of a material suitable for providing a pliable consistency and/or flexibility to the handle (102). Simply using one hand, the razor assembly (100) can be bent substantially at a number of angles without damaging the handle (102), and further without removing the blade in the blade assembly (101). The flexible construction of the handle (102) is such that when a user exerts a manual pressure to the handle (102) during use, the handle (102) flexes and/or bends in response to the pressure and thereby absorbs at least some of the applied pressure.

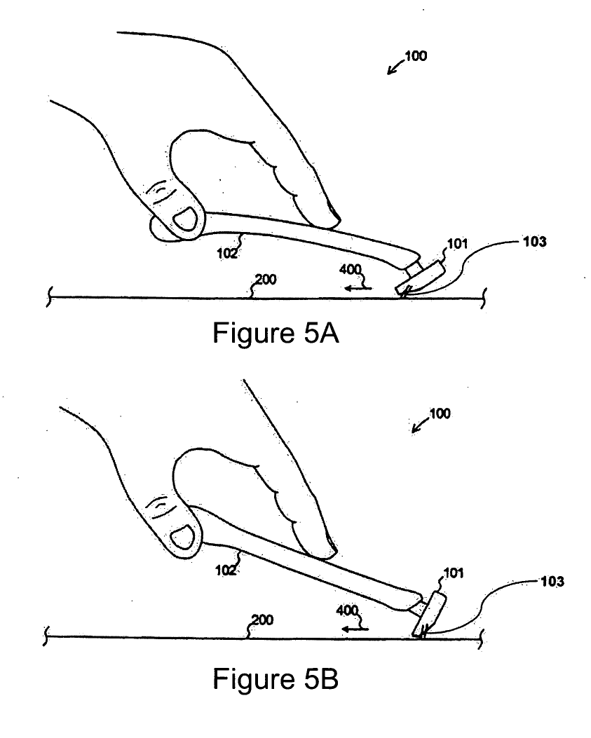

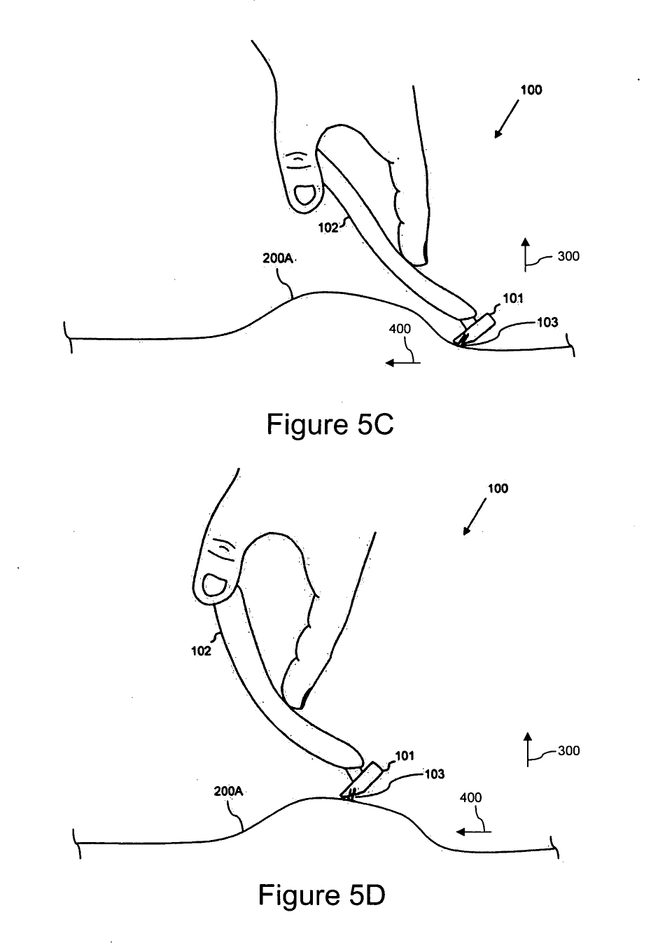

Referring to FIGS. 5A-5D, a user can apply a pressure to the handle (102) when the edges of the razor blades (103) in the blade support assembly (101) are in contact with a surface (200). The handle (102) has sufficient pliable consistency and/or flexibility such that as the user continuously and/or increasingly applies pressure to the handle (102), the handle (102) flexes or bends in response such that the razor blade or blades (103) of the blade support assembly (101) optimally contact the surface (200), e.g., during shaving of the surface, and remain in optimal contact with the surface (200) as the razor assembly (100) traverses the surface (200) in the direction of arrows (400).

In addition, referring to FIGS. 5C and 5D, the material of the handle is suitable for providing a pliable consistency and/or flexibility to the handle (102) allowing the cutting edge of the razor blades (103) of the razor support assembly (101) to adjust to forces encountered, e.g., during shaving, as a result of an uneven or contoured surface (200A), thus compensating for any lack of optimum relationship between the razor blade (103) edges and the surface. The razor blades (103) of the blade support assembly (101) remain in contact with the shaving surface (200) due to the flexible response of the handle (102) to the contours of that surface (200A). As the razor blades (103) of the blade support assembly (101) traverse the contours of the shaving surface (200A), as shown by arrows (400) in FIGS. 5A-5D, the handle (102) can flex and/or bend in response to a surface contour, e.g., an upward curve, such that the blade support assembly (101) flexes or bends upward, as shown by arrows (300) in FIGS. 5C-5D, to adjust a position of the blades (103) contained in the blade support assembly (101) to thereby compensate for the contour (200A). As a result, the razor blades (103) of the blade support assembly (101) can remain in optimal contact with any contour of a shaving surface.

In effect, the pliable and/or flexible properties of the handle (102) help to allow the razor assembly (100) and, in particular, the razor blades (103) of the blade support assembly (101) to establish optimum contact with the surface, e.g., during shaving, and to adjust the position of the razor blades (103) of the blade support assembly (101) when in contact with the surface in response to the contours of the surface that the blade support assembly (101) encounters and in response to a pressure a user applies to the handle (102) during use.

As shown in FIGS. 5A-5D, the razor blades (103) of the blade support assembly (101) travel across the surface (200, 200A) with a substantial uniformity. The razor blades (103) of the blade support assembly (101) generally do not or only minimally lift off the surface (200, 200A), e.g., during shaving, or do not or only minimally bounce on and off the surface (200, 200A). The pliable and/or flexible properties of the handle (102) provide substantially effortless and consistent adjustment of a position of the blade support assembly (101) when in contact with a surface in response to the pressure applied to the handle (102) by a user and/or in response to the contours of the surface (200A) to thereby help to provide a safe and comfortable as well as a substantially uniform shave.

The texturized surface of the handle (104) can include a plurality of protrusions, e.g., raised bumps or other configurations, to provide a handle or an area on the handle (102) with a texture that can serve as a manual user grip.

The invention is not limited to those materials of construction described herein, and anticipates that a number of materials may be used to accomplish the characteristics of the handle (102). A preferred material of construction includes a material suitable for providing flexible properties and/or a pliable consistency to the handle (102). A number of material characteristics can be factors in the construction of the handle (102), and one or more of such factors can be considered in selecting a material of construction of the handle (102). Such factors may include, for example, a material's hardness, density, melt flow index, ultimate tensile strength and/or ultimate elongation. The invention anticipates that other characteristics can be considered. In one embodiment, a measured hardness of a material of construction in terms of its elasticity can be used to select a suitable material of construction. The measured hardness of a material includes an empirical value that can be determined by any method known in the art used to measure a material's hardness, such as, for example, a durometer test using a Shore scale. A Shore durometer test measures a resistance of a material. For example, a durometer test using a Shore A scale is used to measure a resistance of a material toward indentation and provides, as measured by a durometer, an empirical hardness or durometer value. A Shore A scale is typically used in the art to measure the resistance of such materials as, for example, rubbers, elastomers and “soft” plastics (e.g., polyolefin fluoro polymers and vinyls). Other scales can be used to determine the hardness of a material including a Shore D test for hardness testing of plastics. The materials of construction of the handle (102) are only limited to the extent of a material's resilience. For example, a material's resilience can be measured by a durometer test, and/or as demonstrated in terms of a percentage, e.g., 80%, of a material's limit of elasticity, and/or as measured/demonstrated as that point beyond which a material is no longer resilient.

Suitable materials of construction of the handle (102) can include, but are not limited to, a thermoplastic elastomer (“TPE”), a textured plastic, a rubberized plastic, a textured, rubberized plastic, a pliable plastic, a rubber, an elastomer, a metal, paper and any combinations thereof. In one embodiment, the material can include Engage Polyolefin Elastomer, which is an ethylene alpha-olefin copolymer compound, and is a product of DuPont Dow Elastomers of Wilmington, Delaware. The Engage Polyolefin Elastomer can be used as a modifier in TPE to improve or modify the elastic properties of the TPE.

A preferred embodiment of the handle (102) is made of a solid piece of TPE, or thermoplastic elastomer. The TPE can have a density of 0.870 g/cm3, a specific melt flow index (MFI) of 5.0 dg/min, a durometer ranging from about 50 to about 90, and preferably about 75, as measured on the Shore A durometer scale, an ultimate tensile strength of 6.9 Mpa, and an ultimate elongation of >1000%. Other densities, melt flow indices, tensile strengths, durometers, and elongations are possible and envisioned, as noted above. For example, in another embodiment, use of a plastic having a durometer rating of from between 50 and 90 as measured, for example, on a Shore A or Shore D scale is possible.

One alternate embodiment of the invention may include a flexible handle consisting of multiple pieces of TPE or other pliable material.

In addition, in one embodiment, the razor assembly (100) can be constructed by an insert or injection molding process well known in the art whereby the blade support assembly (101) and the handle (102) are configured and arranged such that the razor assembly (100) is a unitary assembly. For instance, the handle (102) can be formed by a mold and/or a molding process whereby a portion of the blade support assembly (101), e.g., a stem portion, is inserted in the mold or mold process such that the blade support assembly (101) is disposed at one end of the handle (102) and the handle (102) is molded or configured around such portion of the blade support assembly (101) to form a unitary assembly (100).

A thermoplastic elastomer (TPE) or other pliable plastic is versatile enough that it may be formed into an unlimited combination of styles, shapes, colors and textures. The present invention, thus, is not limited in this respect and anticipates a variety of forms, shapes and configurations, including, but not limited to, round, oval or tubular, as well as a variety of colors and textures. TPE may also be manufactured with a variance of its pliability. The range of pliability can be chosen such that it helps to provide sufficient rigidity to the assembly to allow comfortable handling by a user during use, and such that the pliability provides sufficient flexibility of the assembly to flex and thereby keep the cutting edge of the razor blades (103) of the blade support assembly (101) at the optimum shaving position on all the contours of a surface. The range of pliability also helps to absorb at least some pressure a user exerts on the assembly during use to help to allow one or more blades (103) disposed in the blade support assembly (101) to come into substantially uniform and optimal contact with a surface, e.g., one or more edges of blades in continuous contact with a surface, with either uniform or varying pressure, thereby providing safer, easier and more comfortable shaving. The invention anticipates the use of materials conducive to a particular application depending on the razor assembly's overall thickness, style and construction and to render the razor assembly duly flexible to accomplish the desired effects of the present invention.

The rigid designs of conventional razor handles and similar shaving devices do not allow the blades to be “self-adjusted” to a surface being shaved. The razor assembly of the invention including the pliable handle attached to the blade support assembly, therefore, is desirable to provide assurance to a user applying a regular level of force to the assembly that one or more blades of the blade support will adjust by the flexing handle and consistently and nearly effortlessly follow the contours of a user's body. Unlike a rigid handle, the handle (102) can absorb some of the unintended pressure a user exerts upon the assembly (101), allowing one or more blades (103) to come into close contact with an area being shaved and with substantially uniform pressure, thereby allowing a safer, more comfortable, shaving experience.

In embodiments of the invention, the flexible handle is constructed of a solid member. In other embodiments of the invention, the flexible handle can include holes or other apertures along the surface of the handle, rather than being a solid member. The handle can have a flexible portion, rather than being a solid flexible member such that the razor assembly can include a razor attachment section, a flexible middle section, and a handle section. Another embodiment of the invention may include a flexible handle consisting of multiple pieces of TPE or other pliable material. Other embodiments are within the scope and spirit of the invention.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A razor assembly comprising:
a razor blade assembly for supporting one or more razor blades; and
a handle, coupled to the razor blade assembly, the handle comprising a flexible material to bend while pressure is applied to the handle.

2. The razor assembly of claim 1 wherein the handle bends to provide continuous contact of at least one edge of one or more edges of the one or more razor blades to a surface.

3. The razor assembly of claim 1 wherein the one or more razor blades are fixedly coupled to the razor blade assembly.

4. The razor assembly of claim 1 wherein the handle further includes a plurality of protrusions providing a texture on a surface of the handle.

5. The razor assembly of claim 1 wherein the handle is comprised of thermoplastic elastomer.

6. The razor assembly of claim 1 wherein the handle is comprised of a pliable plastic.

7. The razor assembly of claim 1 wherein the handle is comprised of a first flexible portion proximal to the razor blade assembly and a second rigid portion distal from the razor blade portion, and wherein the first portion is constructed and arranged to bend while pressure is applied to the handle.

8. A razor assembly comprising:
a razor blade assembly for supporting one or more razor blades; and
a self-adjusting device, coupled to the razor blade assembly, the self-adjusting device comprising a member configured to bend in response to a pressure applied to the self-adjusting device.

9. The razor assembly of claim 8 wherein the member bends in response to a changing topography of a surface with which the razor blade assembly contacts.

10. The razor assembly of claim 8 wherein the self-adjusting means is comprised of a thermoplastic elastomer.

11. The razor assembly of claim 8 wherein the one or more razor blades are non-movably coupled to the razor blade support assembly.

12. A razor assembly comprising:
a razor blade support assembly for accepting one or more razor blades and supporting the one or more razor blades; and
a pliable handle, coupled to the razor blade support assembly, wherein the pliable handle bends as the razor blade support assembly travels across a surface to provide uniform pressure on the surface.

13. The razor assembly of claim 13 wherein the pliable handle twists in response to the pressure applied to the surface.

14. The razor assembly of claim 13 wherein the pliable handle is comprised of thermoplastic elastomer.

15. The razor assembly of claim 13 wherein the pliable handle is comprised of a pliable plastic.
